(19) United States
(12) Patent Application Publication
(10) Pub. No.: US 2023/0409644 A1
(43) Pub. Date: Dec. 21, 2023

(54) SYSTEMS AND METHOD FOR GENERATING LABELLED DATASETS

(71) Applicant: Xero Limited, Te Aro, Wellington (NZ)

(72) Inventors: Yu Wu, Te Aro, Wellington (NZ); Salim Fakhouri, Te Aro, Wellington (NZ); Mohamed Khodeir, Te Aro, Wellington (NZ); Jerome Gleyzes, Te Aro, Wellington (NZ); Soon-Ee Cheah, Te Aro, Wellington (NZ)

(73) Assignee: Xero Limited, Te Aro, Wellington (NZ)

(21) Appl. No.: 18/028,416

(22) PCT Filed: Aug. 19, 2021
(86) PCT No.: PCT/NZ2021/050135

§ 371 Date: Mar. 24, 2023

(30) Foreign Application Priority Data
Feb. 18, 2021 (AU) 2021900421

(51) Int. Cl. G06F 16/906; G06F 16/93

(52) U.S. Cl. CPC G06F 16/906; G06F 16/93

(57) ABSTRACT

A method comprises determining a plurality of documents and for each document of the plurality of documents: (i) providing the document to a numerical representation generation model; (ii) generating, by the numerical representation generation model, a numerical representation of the document; and (iii) determining a document score for the document based on the numerical representation. The method further comprises c) providing the document scores to a clustering module; d) determining, by the clustering module, one or more clusters, each cluster being associated with a class of the documents; e) outputting. by the clustering module, a cluster identifier indicative of the class of each document; and f) associating each document with its respective cluster identifier.

### TECHNICAL FIELD

Embodiments generally relate to systems, methods and computer-readable media for generating labelled datasets. Some embodiments relate in particular to systems, methods and computer-readable media for generating labelled datasets for use in training models to determine or identify attributes, such as entity identifiers, associated with documents. Other embodiments relate to systems, methods and computer-readable media for assessing performance of machine learning models, such as character extraction models and the like.

### BACKGROUND

When an account holder or accountant receives an accounting document, such as an invoice or a receipt, from an entity, the accountant has to determine the entity to which the accounting document relates to input the relevant information into a record or bookkeeping system. However, accounting documents can differ drastically from one entity to another and automated systems often struggle to correctly identify an entity associated with a particular accounting document.

Machine learning models can be trained to generate or predict attributes associated with such accounting documents and to automatically reconcile transactions, or provide meaningful reconciliation suggestions to a user to allow the user to manually reconcile the transactions. However, the effectiveness and accuracy of such models depends largely on the quality of the dataset used to train the model.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Described embodiments relate to a method comprising: a) determining a plurality of documents, b) for each document: i) providing the document to a numerical representation generation model; ii) generating, by the numerical representation generation model, a numerical representation of the document; and iii) determining a document score for the document based on the numerical representation; c) providing the document scores for the documents to a clustering module; d) determining, by the clustering module, one or more clusters, each cluster being associated with a class of the documents; e) outputting, by the clustering module, a cluster identifier indicative of the class of each document; and f) associating each document with its respective cluster identifier.

In some embodiments, each document is associated with a corresponding label of a plurality of labels, and the method further comprises determining a dataset for each label of the plurality of labels, the dataset comprising the documents associated with the label; and performing steps b) to e) for each dataset separately.

The numerical representation may be a multi-dimensional vector, and the method may further comprise providing the numerical representation to a dimensionality reduction model to determine the document score. In some embodiments, the dimensionality reduction model performs Principal Component Analysis (PCA) to generate a dimensionally reduced numerical representation of the character data of the document, and the method may further comprise multiplying the dimensionally reduced numerical representation by the variance-ratio to determine the document score.

The numerical representation may comprise one or more confidence scores for corresponding one of more attributes of the character data, wherein the one or more attributes comprise: (i) amount; (ii) entity; (iii) due date; (iv) bill date; and/or (v) invoice number.

In some embodiments, the method may comprise applying a filter to the document to blur the character data before providing the character data to the numerical representation generation model.

The one or more of the cluster identifiers may be indicative of a low confidence score class of document for which one or more low confidence scores have been allocated and the method may further comprise selecting the documents of the one or more low confidence score classes for label review.

One or more of the cluster identifiers may be indicative of a low confidence score class of document for which one or more low confidence scores have been allocated and the method may further comprise retraining a model used to generate the confidence scores using documents from the one or more low confidence score classes of document.

In some embodiments, determining, by the clustering module, one or more clusters, comprises: determining a plurality of histogram bins based on the document scores; determining a bin score for each document; and grouping histogram bins into clusters. Grouping histogram bins into clusters may comprise determining local minima of the histogram bins as the clusters. In some embodiments, determining, by the clustering module, one or more clusters, may comprise performing k-means clustering, density-based spatial clustering (DBSCAN) or hierarchical clustering.

In some embodiments, the method may further comprise: for each document: providing the character data to an attribute determination model; determining an attribute associated with the document based on the character data; and associating the document with the determined attribute as the label.

In some embodiments, each document comprises image data, and the method further comprises: for each document: extracting the image data from the document; providing the image data to an attribute determination model; determining, by the attribute determination module, an attribute associated with the document based on the image data; and associating the document with the determined attribute as the label.

Each document may comprise image data, and the method may further comprise: for each document: extracting the image data from the document; providing the image data to an image-based numerical representation generation module; determining by the image-based numerical representation generation module, an image-based numerical representation of the document; providing the character data to a character-based numerical representation generation module; determining by the character-based numerical representation generation module, a character-based numerical representation of the document; providing, to a consolidated numerical representation generation module, the image-based numerical representation of the document and the character-based numerical representation of the document; and generating, by the consolidated numerical representation generation module, a combined numerical representation of the character data and the image data of the document; providing the combined numerical representation to an attribute prediction module; and determining, by the attribute prediction module, the attribute associated with the document; and associating the document with the determined attribute as the label.

For example, the attribute may be an entity associated with the document. In some embodiments, the documents may be derived from previously reconciled accounting documents of an accounting system, each of which has been associated with a respective entity, and wherein the label of each document is indicative of the respective entity. The document may be an accounting document and the class of documents may include one or more of: (i) an invoice; (ii) a credit note; (iii) a receipt; (iv) a purchase order; and (v) a quote.

Some embodiments relate to a system comprising: one or more processors; and memory comprising computer executable instructions, which when executed by the one or more processors, cause the system to perform any one of the described methods.

Some embodiments relate to a computer-readable storage medium storing instructions that, when executed by a computer, cause the computer to perform any one of the described methods.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Various ones of the appended drawings merely illustrate example embodiments of the present disclosure and cannot be considered as limiting its scope.

FIG. 1 is a schematic example of a process for generating labelled datasets, according to some example embodiments;

FIG. 2 is a schematic diagram of a communication system comprising a system in communication with one or more computing devices and/or third party systems across a communications network, according to some embodiments; and

FIG. 3 is a process flow diagram of a method of generating labelled datasets, according to some embodiments.

### DESCRIPTION OF EMBODIMENTS

Embodiments generally relate to systems, methods and computer-readable media for generating labelled datasets. Some embodiments relate in particular to systems, methods and computer-readable media for generating labelled datasets for use in training models to determine or identify attributes, such as entity identifiers, associated with documents. Other embodiments relate to systems, methods and computer-readable media for assessing performance of machine learning models, such as character extraction models and the like.

The quality of datasets used to train a machine learning model directly impacts the effectiveness of the model, that is, how well the model works. It is therefore important that datasets include examples that will have a positive impact on any model being trained. Records or documents associated with a particular entity (for example, originating with the entity, or generated or issued by the entity) may take various forms and accordingly, relying on entity labels of representative numerical representations or embeddings of such documents can lead to problems when training entity prediction models in particular.

This is particularly problematic where the database from which training examples are being extracted comprises financial or accounting records, such as those accessible to an accounting system that maintains accounts for a large number of entities. The accounting records available to the accounting system are likely to include receipts, invoices, credit notes, and the like, and more than one of these types or categories of documents may originate with the same entity. For example, a particular entity may issue an invoice and also provide a receipt. And although there will be similarities between the documents, such as the entity name and description of goods, and the “look and feel” of the document, there will also be differences between the two types of documents. This is of particular importance when generating an entity index that includes a representative embedding or numerical representation (“fingerprint”) of each entity of a plurality of entities based on documents associated with the respective entity, as described in the Applicant's Australian provisional patent application no. 2021900419 entitled “Systems and methods for generating document numerical representations”, filed on 18 Feb. 2021, the entire content of which is incorporated herein by reference. This is because the differences between document types from the same entity can negatively impact the quality of the representative numerical representation. Accordingly, an index of such representative numerical representation for use in readily identifying an entity associated with a candidate document may not perform as intended. For example, a numerical representation of a candidate credit note from entity A may actually more closely resemble the representative numerical representation of a candidate credit note from entity B, and this may be because the representative numerical representation of candidate A in the index was generated using a dataset that included few or no credit notes.

The described embodiments provide a specific method for recognising clusters or types of documents, which may, for example, be associated with particular entities and in some embodiments, generating entity specific datasets comprising data frames for each type or class of document associated with the entity in a database. The data frames may include a specific class or cluster identifier indicative of the type of document.

In some embodiments, the specific class or cluster identifier can be indicative of documents and/or specific attributes of documents that a model used to generate the representative numerical representations is having difficulty in confidently predicting or extracting information from. By identifying such classes of documents, the relevant documents and/or labels can be assessed by another model, and or a human, to annotate the documents with high confidence label(s), which can then be used to train the model to achieve better performance with the particular class of document.

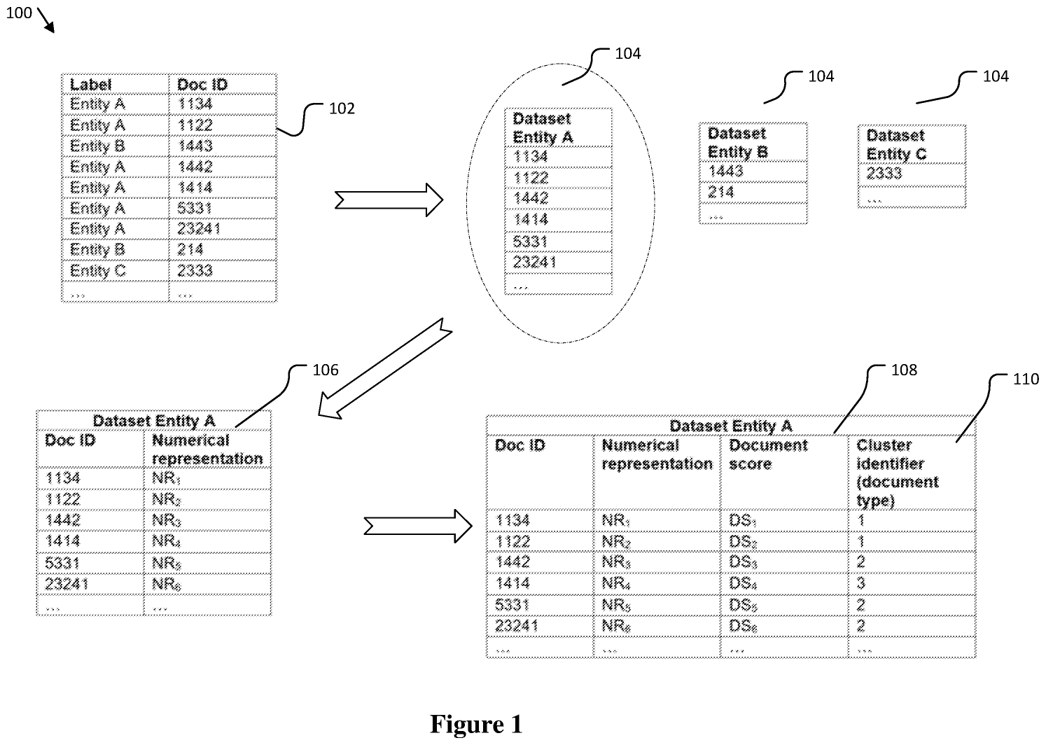

FIG. 1 is a schematic of a process 100 for generating a dataset of labelled documents associated with an entity, according to some embodiments.

A document set 102 comprising a plurality of documents is determined from a database. In some embodiments, the documents are each associated with a respective entity (Entities A, B and C), and a respective document identifier. The document set is grouped or ordered into a plurality of datasets 104, each dataset being associated with a specific entity and comprising at least one document. The example datasets 104 of FIG. 1 include Dataset Entity A, Dataset Entity B, and Dataset Entity C.

For each document in the document set 102 or in each dataset 104, a numerical representation 106 of the document is generated and may be stored in a data structure or data frame associated with the respective document. In some embodiments, the numerical representation 106 may comprise attribute data of the document, which may for example be character data (for example, such as a data string) or image data or both. In some embodiments, the numerical representation 106 may comprise confidence score(s) associated with the confidence of a model, such as a character extraction model, in extracting respective attribute value(s) from the document.

A document score 108 is then determined for the document based on the numerical representation. For example, in some embodiments, the document score is the numerical representation, or a dimensionally reduced version or embedding of the numerical representation. For example, the numerical representation may be dimensionally reduced using Principal Component Analysis (PCA), or any other suitable technique. In the case that the numerical representation comprises confidence scores, the document score may comprise the confidence score(s), or a dimensionally reduced version of the confidence score(s). Accordingly, the document score may be a multi-dimensional vector or indeed, a single value score. The document score may be stored in the associated data frame.

Cluster(s) 110 are identified based on the scores for documents associated with a particular entity, and cluster identifiers are generated. In some embodiments, a plurality of histogram bins are determined based on the document scores, with each document being allocated to a respective histogram bin and the histogram bins are grouped into clusters. The cluster identifiers are indicative of a type or class of document, and an associated cluster identifier may be stored in the data frame of each document. Generating cluster identifiers using histograms tends to provide good empirical performance and/or may be computationally efficient, improving computing resource utilisation. In other embodiments, other clustering techniques may be employed.

By determining clusters based on the document scores, one or more different classes of documents can be identified, and the corresponding numerical representation labelled as an example of a particular class of document. Where entity labelled numerical representations of documents are clustered, classes of documents associated with each entity can be identified, and the corresponding numerical representation can be labelled as an example of a particular class of document associated with that entity. Classes may be specific in that all documents associated with a class may be of a particular type, such as a receipt, an invoice or a credit note, or maybe more generic and relate to a particular category such as financial documents, which may include documents of different types classified as belonging to the category. For example, a category may be financial documents, advertisements or personal correspondence, whereas a type of document may be a subset of a category such as receipt, an invoice, credit note, etc.

In some embodiments, where the numerical representation 106 comprises confidence score(s) associated with the confidence of a model in extracting respective attribute value(s) from the document, the one or more classes identified by the cluster identifiers are indicative of a class(es) of documents having relatively similar predictive scores. In other words, the model used to generate the document scores determined one or more similar confidence scores in being able to accurately extract attribute values for one or more attributes of the document. Documents of the same class are likely to look more similar to each other and/or include similar text, which may be located in similar positions. Accordingly, the model generating the document scores is likely to have similar confidence scores for attributes of the same types of documents. That is, the model is likely to struggle or excel in similar ways with similar types of documents. For example, if the model has trouble extracting a bill amount from a receipt associated with a particular entity, all receipt type documents or receipt type documents associated with the entity, will likely be allocated similar document scores and are likely to be clustered together. Having identified one or more cluster identifiers as being indicative of document class(es) the model struggles with (i.e. having relatively low confidence scores), the model may be retrained specifically with documents of that class to improve its performance. In some embodiments, the documents may be reviewed and annotated by a different model, or by a human, and those relabelled or annotated documents may be used to retrain the model. Accordingly, performance issues with predictive models in particular areas can be readily identified and their performance improved upon.

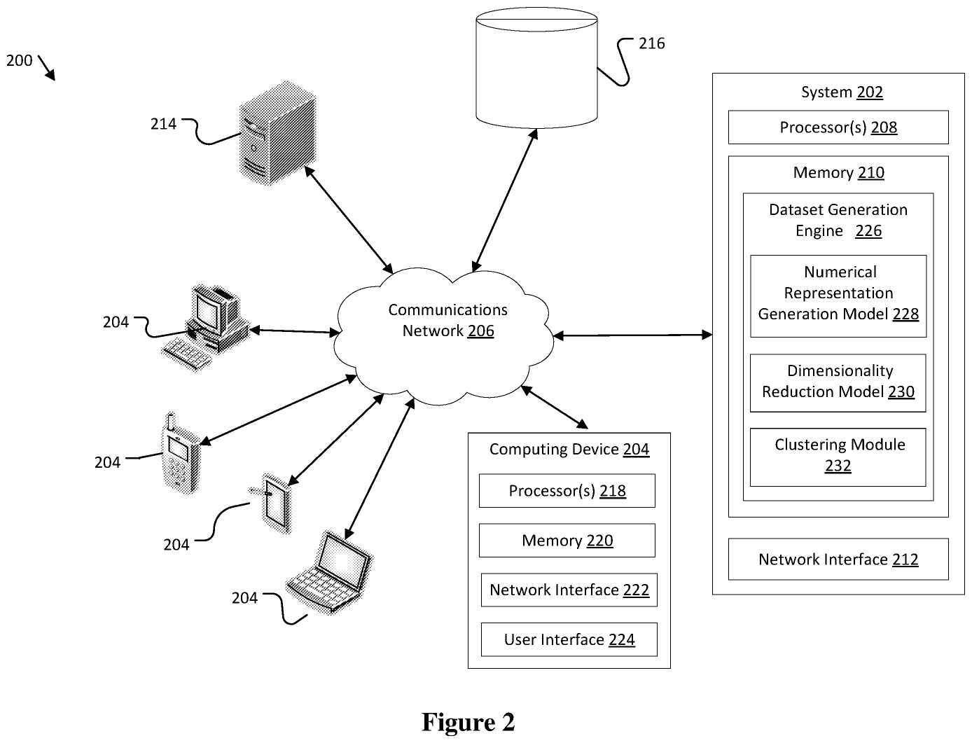

FIG. 2 is a schematic of a communications system 200 comprising a system 202 in communications with one or more computing devices 204 across a communications network 206. For example, the system 202 may be an accounting system. Examples of a suitable communications network 310 include a cloud server network, wired or wireless internet connection, Bluetooth™ or other near field radio communication, and/or physical media such as USB.

The system 202 comprises one or more processors 208 and memory 210 storing instructions (e.g. program code) which when executed by the processor(s) 208 causes the system 202 to manage data for a business or entity, provide functionality to the one or more computing devices 204 and/or to function according to the described methods. The processor(s) 208 may comprise one or more microprocessors, central processing units (CPUs), application specific instruction set processors (ASIPs), application specific integrated circuits (ASICs) or other processors capable of reading and executing instruction code.

Memory 210 may comprise one or more volatile or non-volatile memory types. For example, memory 210 may comprise one or more of random access memory (RAM), read-only memory (ROM), electrically erasable programmable read-only memory (EEPROM) or flash memory. Memory 210 is configured to store program code accessible by the processor(s) 208. The program code comprises executable program code modules. In other words, memory 210 is configured to store executable code modules configured to be executable by the processor(s) 208. The executable code modules, when executed by the processor(s) 208 cause the system 202 to perform certain functionality, as described in more detail below.

The system 202 further comprises a network interface 212 to facilitate communications with components of the communications system 200 across the communications network 206, such as the computing device(s) 204, database 214 and/or other servers 216. The network interface 212 may comprise a combination of network interface hardware and network interface software suitable for establishing, maintaining and facilitating communication over a relevant communication channel.

The computing device(s) 204 comprise one or more processors 218 and memory 220 storing instructions (e.g. program code) which when executed by the processor(s) 218 causes the computing device(s) 204 to cooperate with the system 202 to provide functionality to users of the computing device(s) 204 and/or to function according to the described methods. To that end, and similarly to the system 202, the computing devices 204 comprise a network interface 222 to facilitate communication with the components of the communications network 206. For example, memory 220 may comprise a web browser application (not shown) to allow a user to engage with the system 202.

The computing device 206 comprises a user interface 224 whereby one or more user(s) can submit requests to the computing device 316, and whereby the computing device 206 can provide outputs to the user. The user interface 224 may comprise one or more user interface components, such as one or more of a display device, a touch screen display, a keyboard, a mouse, a camera, a microphone, buttons, switches and lights.

The communications system 200 further comprises the database 214, which may form part of or be local to the system 202, or may be remote from and accessible to the system 202. The database 214 may be configured to store data, documents and records associated with entities having user accounts with the system 202, availing of the services and functionality of the system 202, or otherwise associated with the system 202. For example, where the system 202 is an accounting system, the data, documents and/or records may comprise business records, banking records, accounting documents and/or accounting records.

The system 202 may also be arranged to communicate with third party servers or systems (not shown), to receive records or documents associated with data being monitored by the system 202. For example, the third party servers or systems (not shown), may be financial institute server(s) or other third party financial systems and the system 202 may be configured to receive financial records and/or financial documents associated with transactions monitored by the system 202. For example, where the system 202 is an accounting system 202, it may be arranged to receive bank feeds associated with transactions to be reconciled by the accounting system 202, and/or invoices or credit notes or receipts associated with transactions to be reconciled from third party entities.

Memory 210 comprises a dataset generation engine 226, which when executed by the processors(s) 208, causes the system 202 to generate or create datasets of labelled documents. In some embodiments, the dataset generation engine 226 is configured to generate labelled documents for use in training models to determine or identify attributes, such as entity identifiers, as may be associated with accounting or bookkeeping records, for example. The dataset generation engine 226 comprises a numerical representation generation model 228 and a clustering module 232. In some embodiments, the dataset generation engine 226 also comprises a dimensionality reduction model 230.

The numerical representation generation model 228 is configured to generate numerical representations or embeddings of documents. In some embodiments, the numerical representation 106 may comprise, or be indicative of, attribute data of the document, which may, for example, be determined at least in part using character data (such as data strings or character strings) of documents or image data or both. The numerical representation generation model 228 may be configured to extract data from the document(s) that relate to specific attributes and generate a vector representation of the data. In some embodiments, the numerical representation generation model 228 may be a transformer-based model trained to extract values for specific attributes from documents, such as financial documents. For example, the attributes may comprise amount, bill date, vendor, etc.

In some embodiments, the numerical representation generation model 228 may be a subcomponent of a text extraction model (not shown) and the generated numerical representation may correspond with an intermediate layer of the text extraction model, such as the intermediate layer before or immediately preceding a classification layer of a text extraction model (not shown).

In some embodiments, the numerical representation generation model 228 may be based upon the architecture described in: Devlin J et al. (2019) “BERT: Pre-training of Deep Bidirectional Transformers for Language Understanding” (https://arxiv.org/pdf/1810.04805.pdf). In other embodiments, the numerical representation generation model 228 may include an architecture such as Xception or Resnet or the like.

In some embodiments, the numerical representation generation model 228 may be based on models described in PCT application no. PCT/AU2020/051140, entitled “Docket Analysis Methods and Systems”, and filed on 22 Oct. 2020, the entire content of which is incorporated herein by reference.

In some embodiments, the numerical representation generation model 228 may be based on models described in the Applicant's co-pending Australia provisional patent application No. 2021900419, entitled “Systems and methods for generating document numerical representations”, filed on 18 Feb. 2021, the entire content of which is incorporated herein by reference.

In some embodiments, the numerical representation generation model 228 comprises a prediction model to determine or generate one or more prediction or confidence values or scores indicative of the model's confidence in accurately predicting or determining corresponding one or more attribute values for respective attributes of the character data. For example, such attributes or features may comprise one or more of: (i) amount; (ii) entity; (iii) due date; (iv) bill date; (v) invoice number; (vi) tax amount and/or (vii) currency. Accordingly, the numerical representations comprise, or are indicative of, the one or more prediction or confidence values or scores indicative of the model's confidence.

In some embodiments, the numerical representation generation model 228 generates numerical representations comprising multi-dimensional vectors. In such embodiments, the dataset generation engine 226 may use the dimensionality reduction model 230 to transform the multi-dimensional vector into a lower-dimensional space. For example, the dimensionality reduction model 230 may use Principal Component Analysis (PCA) to generate a dimensionally reduced numerical representation of the character data of the document. However, it will be appreciated that any other dimensionality reduction technique may be used.

The dataset generation engine 226 determines a document score for each document based on, or as a function of, the numerical representation or the dimensionally reduced numerical representation, and provides the document scores for each dataset to the clustering module 232. As previously discussed, in some embodiments, the document score may be the numerical representation, or the dimsionally reduced numerical representation.

The clustering module 232 is configured to determine one or more clusters based on the document scores, where each cluster is associated with a class of the documents. In some embodiments, the class may be indicative of a type of document, such as may originate with a particular entity. For example, the clustering module 232 may be configured to determine types of documents associated with a given entity, such as receipts, invoices, and statement of accounts. In some embodiment, the class may be indicative of a category of document, to which one or more types of documents may belong. The clustering module 232 outputs a cluster identifier indicative of the class of each document. The dataset generation engine 226 then associates each document in the dataset with the respective determined cluster identifier.

In some embodiments, where the document score is derived from the numerical representation of predictive scores, the one or more cluster identifiers may not only be indicative of different classes of documents, but how confident the model is in predicting attribute values for such document class(es). Having identified one or more cluster identifiers as being indicative of document classes the model struggles with, or for which model certainty and/or performance warrants further improvements, the system 202 may cause the model to be retrained specifically with documents of that class. In some embodiments, the documents may be reviewed and annotated by a different model, or by a human, and those relabelled or annotated documents may be used to retrain the model.

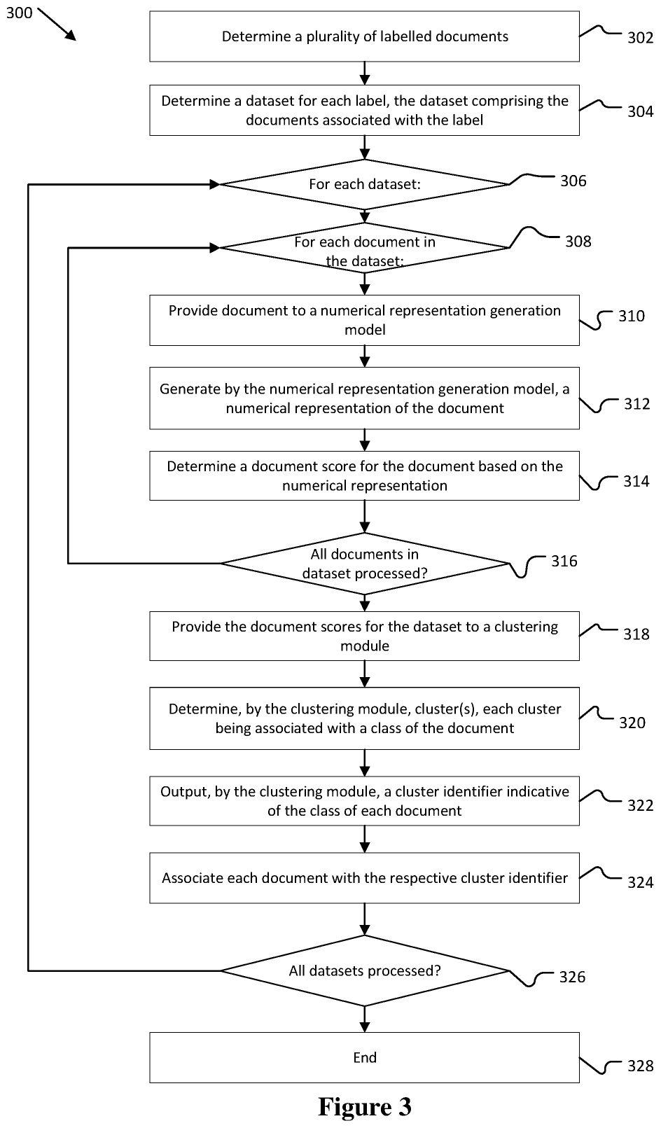

FIG. 3 is a process flow diagram of a method 300, according to some embodiments. The method 300 may, for example, be implemented by the processor(s) 208 of system 202 executing instructions stored in memory 210.

At 302, the system 202 determines a plurality of documents. For example, the document may be an accounting document, such as an invoice or a receipt or a financial document, such as a bank statement associated with a particular type of bank account. Each document is associated with a corresponding label of a plurality of labels. In some embodiments, the corresponding label is an attribute of the document, such as an entity associated with the document, such as the entity responsible for issuing or generating the document. Each document comprises character data (for example, a data string). For example, the character data may be a collation of all or a filtered subset of characters and/or text of the document. In some embodiments, some or all of the documents of the plurality of documents comprise one or more images. In some embodiments, the documents may be pre-processed to remove extraneous characters or material, and/or to format the character data, for example.

At 304, in some embodiments, the system 202 may determine a dataset for each label of the plurality of labels. The dataset comprises the documents associated with the label. For example, where the label is an entity name or identifier, the system 304 determines a dataset for each entity. In some embodiments, only datasets comprising more than a threshold number of documents (for example, 100 documents) will be considered and processed by the system.

As indicated at 306, steps 310 to 324 may be performed by the system 202 for each determined dataset, and as indicated at 308, steps 310 to 314 may be performed for each document in the dataset.

At 310, the system 202 provides the document to a numerical representation generation model. At 312, the numerical representation generation model 228 generates a numerical representation or embedding of the document. The numerical representation may be a multi-dimensional vector.

In some embodiments, the numerical representation generation model 228 may be configured to extract characters or character strings from the document that relate to specific attributes and generate a vector representation of those characters or character strings.

In some embodiments, the numerical representation generation model 228 may be a transformer-based model trained to extract values for specific attributes from documents. For example, the numerical representation generation model 228 may be trained to receive as input, a document, and to provide as an output, one or more attributes of the document. More specifically, the inputs provided may include sequences of tokens, each with corresponding x,y coordinates, and wherein the order of the inputs is itself an input. In this embodiment, the numerical representation generation model 228 comprises an embedding layer through which the tokens pass, and output vectors from the embedding layer are concatenated with custom features including the x,y coordinates. The output vectors are then passed through a plurality of transformer layers, for example six transformer layers, to provide output numerical representations. The output numerical representations may then be fed into two different heads of a model. A special classification token, the [CLS] token, is fed into the first head or first model which may comprise a feed forward neural network followed by a softmax function, the output of which is indicative of one or more categories for transaction currency. For example, in some embodiments, the output may be indicative of the probability or probabilities that the document includes one or more transaction currencies, such as USD, AUD, NZD, and the like. Accordingly, in this example, determination of a transaction currency is performed in a different manner to the determination of other attributes. The output numerical representations, other than the [CLS] token, are provided to a second head or model which may also comprise a feed forward neural network followed by a softmax function, and the output of which is a classification of each token as an attribute of the document, such as amount, bill date, vendor, due date, invoice number, tax, or nothing. The cost function is a combination of the cross entropy losses from the two heads, and the currency head loss may be scaled by 1/100.

Where the input documents are financial documents, the attributes or labels determined may include a vendor identifier, a transaction date, a transaction amount, a transaction currency, for example. Further information about this embodiment may be found in “BERT: Pre-training of Deep Bidirectional Transformers for Language Understanding”, Jacob Devlin et al, 24 May 2019 (https://arxiv.org/pdf/1810.04805.pdf). In some embodiments, the numerical representation generation model 228 may further comprise an ‘Adam’ based neural network optimiser described in the paper titled ‘Adam: A Method for Stochastic Optimization’ available at https://arxiv.org/abs/1412.6980. For example, the numerical representation generation model 228 may be trained end-to-end with “Adam” with weight decay. For example, the learning rate may be 1e-4, batch size may be 9, and max seq length may be 512.

In some embodiments, the numerical representation generation model 228 may be based on models described in PCT application no. PCT/AU2020/051140, entitled “Docket Analysis Methods and Systems”, and filed on 22 Oct. 2020, the entire content of which is incorporated herein by reference.

In some embodiments, the numerical representation generation model 228 may be a subcomponent of a text extraction model (not shown) and the generated numerical representation may correspond with an intermediate layer of the text extraction model, such as the intermediate layer before or immediately preceding a classification layer of the text extraction model (not shown). For instance, the intermediate layer may include the output numerical representations of the preceding examples, which precede the second head or model used for classification.

In some embodiments, the numerical representations may be generated according to methods described in the Applicant's co-pending Australian provisional patent application No. 2021900419, entitled “Systems and methods for generating document numerical representations”, filed on 18 Feb. 2021, the entire content of which is incorporated herein by reference, and as discussed in more detail below.

In some embodiments, prior to providing the document to a numerical representation generation model, the system 202 applies a filter to the document to deemphasise specific attribute data. For example, the system 202 may apply a Gaussian filter to blur the document image. This may assist in deemphasising the content of the document, that is, the text or characters of the document, relative to the overall shape, or “look and feel”.

In some embodiments, the numerical representation generation model 228 comprises a prediction model configured to receive as an input, the document, and to derive one or more prediction or confidence scores indicative of the probability or certainty of the prediction model in detecting or extracting respective one or more attribute values from the document. For example, attributes or features associated with respective scores may include one or more of: (i) amount; (ii) entity; (iii) due date; (iv) bill date; (v) invoice number; (vi) tax amount and/or (vii) currency. An output from the prediction model may comprise a numerical representation or vector representation of prediction scores. For example, an output from the prediction model including scores for all of these attributes would be a 5-D vector representation. In some embodiment, the prediction model comprises a transformer-based neural network, such as any of the examples described herein.

In some embodiments, by using the prediction model to determine the numerical representation, the method 300 may further provide for an assessment of the performance of the prediction model, and may assist in identifying documents and/or specific attributes of documents that the model is having difficulty in predicting, as discussed in further detail below.

At 314, the system 202 determines a document score for the document based on the numerical representation. In some embodiments, the document score may be the numerical representation. In some embodiments, the system 202 provides the numerical representation to a dimensionality reduction model 230 to determine the document score. For example, the dimensionality reduction model 230 may perform Principal Component Analysis (PCA) to generate a dimensionally reduced numerical representation of the character data of the document. In some embodiments, the system 202 may determine the document score based on or as a function of the dimensionally reduced numerical representation. For example, the system 202 may multiply the dimensionally reduced numerical representation by the variance-ratio to determine the document score. In some embodiments, the system 202 may determine the document score based on the first and second principal components, which may be sufficient to capture the fundamental difference between documents, but not necessarily the difference in context or characters/text. In some embodiments, the document score may be the dimensionally reduced numerical representation.

At 316, the system 202 may determine whether all of the documents in the dataset have been processed. If they have not, the method reverts to 308, and a next document from the dataset is selected for processing, and steps 310 to 314 are repeated for this next document. On the other hand, if all of the documents in the dataset have been processed, the method moves to step 318.

At 318, the system 202 provides the document scores for the dataset to a clustering module 232.

At 320, the clustering module 232, determines one or more clusters based on the document score. Each determined cluster is associated with a class of the documents. In some embodiments, the class may be indicative of a type of document, such as may originate with a particular entity. For example, the clustering module 232 may determine a number of classes of documents associated with a given entity, such as receipts, invoices, and statement of accounts.

In some embodiments, the clustering module 232 is configured to determine a plurality of histogram bins based on the document scores, and to determine a bin score or value for each document. The clustering module 232 may then group the histogram bins into clusters. In some embodiments, the clustering module 232 groups the histogram bins into clusters by determining local minima of the histogram as the clusters. For example, the clustering module 232 may be configured to smooth (i.e. apply a smoothing function to) the histogram, compute the derivatives of the smoothed histogram, and determine minima positions using the derivatives. The clustering module 232 may determine clusters using the determined minima positions, each cluster being indicative of a different class of document.

In some embodiments, the clustering module 232 filters out small clusters. For example, in some embodiments, a number of documents in each cluster is compared with a threshold cluster size, and if the number of documents in the cluster falls short of the threshold, the cluster is filtered out or excluded. For example, the threshold cluster size may be four.

In some embodiments, the clustering module 232 is configured to perform other clustering techniques such as k-means clustering, density-based spatial clustering (DBSCAN) or hierarchical clustering, for example, to determine the one or more clusters based on the document score.

At 322, the system 202 outputs, by the clustering module 232, a cluster identifier indicative of the class of each document.

At 324, the system 202 associates each document in the dataset with the respective cluster identifier, and in some embodiments, also with the determined numerical representation.

At 326, the system 202 may determine whether all datasets have been processed. If they have not, the method reverts to 306, and a next dataset is selected for processing, and steps 308 to 322 are repeated for this next dataset. On the other hand, if all of the datasets have been processed, the method moves to step 326, at which the process ends.

In some embodiments, the plurality of labelled documents used at step 302 are derived from previously reconciled documents of an accounting system, each of which has been associated with a respective entity, and wherein the label of each document is indicative of the respective entity.

In other embodiments, the label or attribute of the document is determined by providing the character data to a character-based attribute determination model configured to determine an attribute associated with the document based on the character data. In some embodiments, for documents comprising image data (for example, an image of the document or at least one image provided in the document), the label or attribute of a document is determined by extracting the image data from the document and providing it to an image-based attribute determination model configured to determine an attribute associated with the document based on the image data. In other embodiments where the document includes image data, the label or attribute of the document may be determined by a consolidated or concatenated character and image based attribute determination model. For example, the consolidated character and image based attribute determination model may be configured to receive as an input, a combined numerical representation of the document generated from an image-based numerical representation of the document and a character-based numerical representation of the document. An example of a suitable consolidated character and image based attribute determination model is described in the Applicant's co-pending Australian provisional patent application No. 2021900419, entitled “Systems and methods for generating document numerical representations”, filed on 18 Feb. 2021, the entire content of which is incorporated herein by reference.

As mentioned above, where the prediction model is used to determine the numerical representation (step 312), the method 300 may further provide for an assessment of the performance of the prediction model, and may assist in identifying documents and/or specific attributes of documents that the model is having difficulty in predicting, as discussed in further detail below.

For example, one or more of the clusters may identify documents that were allocated relatively low predictive or confidence scores relative to other documents. Therefore in some embodiments, the system 202 may further determine one or more cluster identifiers as indicative of documents associated with relatively low predictive or confidence scores (for example, less than an acceptability threshold). The system 202 may be configured to determine from the numerical or vector representation of the character data of the one or more documents associated with the determined one or more cluster identifiers, one or more attributes of the document(s) having relatively low predictive or confidence scores. Accordingly, the determined cluster identifiers may be used to determine documents, and/or attributes of documents, associated with particular datasets or entities that the model is not accurately or sufficiently confidently interpreting or classifying or extracting text from.

In some embodiments, the system 202 may be configured to select documents having cluster identifiers of a particular class identified as being problematic for the model. The system 202, or indeed a different system, may then cause the model to be specifically retrained using the identified class(es) of documents to better identify attributes of similar type documents. Accordingly the method 300 assists in identifying areas in which the model is struggling or not performing to a given standard and to improve the performance for the model in those specific areas.

In some embodiments, prior to providing specific datasets of documents to the model for retraining purposes, the selected documents or datasets may be provided to a different model or to a user to ensure the documents are annotated or labelled with high confidence labels. It may be the case that the model is struggling with particular documents class(es) because the documents used to train the model were not labelled accurately. Accordingly, the method 300 provides for a quality control assessment of the labels of documents of datasets, identifying potentially erroneous labelled document which may benefit from human input and annotation, without needing to have all document labels of the datasets reviewed and annotated by a human, which can be expensive and inefficient.

For exemplary purposes, the following use cases are provided.

A first use case relates to performing the method 300 of FIG. 3 to generate labelled datasets, and in particular, labelled example documents, for use in training models.

Consider a dataset of example documents which may include one or more different types of documents, such as invoices, debit notes, credit notes, receipts etc. In some cases, the dataset of example documents may be associated or originate from vendor #A, but in other cases, the dataset may include example documents from different vendors.

For each document, use a pre-trained model to determine a numerical representation of the document. For example, an input to the model may be an image of the document, character or text data from the document, or both. Where image data is provided to the model, in some embodiments, Gaussian blurring may be performed prior to blur the image data prior to providing it to the model.

Determine a document score for each document. The document score may be the numerical representation (which may be a multi-dimensional vector), or may be a dimensionally reduced numerical representation and/or may be a single value.

Cluster the document scores to identify document groups within the dataset with similar document scores. The documents with similar document scores are considered as being documents with common or similar attributes, such as class of document. Allocate each cluster or document group a cluster identifier, which is indicative of the attributes, and accordingly of the class or type of document.

A second use case relates to performing the method 300 of FIG. 3 to identify subsets of training data (for example, document classes) with which a model has low confidence in predicting attributes of the training data.

Consider a dataset of example documents which may include one or more different types of documents, such as invoices, debit notes, credit notes, receipts etc. In some cases, the dataset of example documents may be associated or originate from vendor #A, but in other cases, the dataset may include example documents from different vendors.

For each document, use a pre-trained model to determine confidence scores in making predictions about attributes of the document. For example, the pre-trained model may be configured to receive, as an input, the document and to provide, as an output, a vector of confidence scores associated with the confidence or certainty the model has in being able to accurately extract respective attributes from the document.

Determine a document score for each document. The document score may be a vector of the confidence scores, or may be a dimensionally reduced vector of confidence scores or may be a single value.

Cluster the document scores to identify document groups within the dataset with similar document scores, and accordingly, where confidence about the predictions is similar Allocate each cluster or document group a cluster identifier, which is indicative of an attribute such as the class of the document. Documents for which the model has similar confidence in predicting its attributes are likely to have similar documents scores, and accordingly to be grouped together in the same cluster. As the model is likely to determine or generate similar confidence scores and accordingly document scores for similar classes of document, the document groups or clusters will be indicative of documents with similar attributes, such as types of documents (e.g., invoices, receipts, credit notes etc.) or categories of documents (e.g. financial documents, advertisements, personal correspondence). Furthermore, clusters with relatively low document scores, which are based on the confidence scores, are indicative of documents that the model is underperforming or struggling with. Accordingly, these clusters can inform which documents the model needs to be trained or retrained on to improve the overall performance of the model.

For either use case, and depending on the nature of the documents to be clustered, and/or the features used to generate the numerical representation, and accordingly, the document score, the described processes may be capable of distinguishing between documents of different entities, documents of different class, type, documents associated with a broader or more general classification or category, such as financial documents, advertisements, personal correspondence etc. For example, each category may comprise one or more types of document associated with the category; financial documents may include documents types receipt, invoice, credit note etc. In some embodiments, the class may be invariant to the vendor or entity who issued the document, or a country of origin etc.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method comprising:
a) determining a plurality of documents associated with an entity;
b) for each document:
i) providing a document to a numerical representation generation model;
ii) generating, by the numerical representation generation model, a numerical representation of the document; and
iii) determining a document score for the document based on the numerical representation, wherein the document score comprises one or more confidence scores for corresponding one or more attributes of the document;
c) providing document scores for the documents to a clustering module;
d) determining, by the clustering module, one or more clusters, each cluster being associated with a class of the documents;
e) outputting, by the clustering module, a cluster identifier indicative of the class of each document; and
f) associating each document with its respective cluster identifier.

2. The method of claim 1, wherein each document is associated with a corresponding label of a plurality of labels, and the method further comprises:
determining a dataset for each label of the plurality of labels, the dataset comprising the documents associated with the label; and
performing steps b) to e) for each dataset separately.

3. The method of claim 1, wherein the numerical representation is a multi-dimensional vector, and wherein the method further comprises:
providing the numerical representation to a dimensionality reduction model to determine the document score.

4. The method of claim 3, wherein the dimensionality reduction model performs Principal Component Analysis (PCA) to generate a dimensionally reduced numerical representation of the document, and the method further comprises:
multiplying the dimensionally reduced numerical representation by a variance-ratio to determine the document score.

5. The method of claim 1, wherein the one or more attributes comprise: (i) amount; (ii) entity; (iii) due date; (iv) bill date; (v) invoice number; (vi) tax amount; and/or (vii) currency.

6. The method of claim 1, comprising:
applying a filter to the document to blur image data of the document before providing the filtered document to the numerical representation generation model.

7. The method of claim 1, wherein one or more cluster identifiers are indicative of a low confidence score class of document for which one or more low confidence scores have been allocated and the method further comprises:
selecting the documents of one or more low confidence score classes for label review.

8. The method of claim 1, wherein one or more cluster identifiers are indicative of a low confidence score class of document for which one or more low confidence scores have been allocated and the method further comprises:
retraining a model used to generate the confidence scores using documents from one or more low confidence score classes of document.

9. The method of claim 1, wherein determining, by the clustering module, one or more clusters, comprises:
determining a plurality of histogram bins based on the document scores;
determining a bin score for each document; and
grouping histogram bins into clusters.

10. The method of claim 9, wherein grouping histogram bins into clusters comprises determining the clusters as respective local minima of the histogram bins.

11. The method of claim 1, wherein determining, by the clustering module, one or more clusters, comprises performing k-means clustering, density-based spatial clustering (DBSCAN) or hierarchical clustering.

12. The method of claim 1, wherein each document comprises character data, and the method further comprising:
for each document:
providing the character data to an attribute determination model;
determining an attribute associated with the document based on the character data; and
associating the document with the determined attribute as a label.

13. The method of claim 1, wherein each document comprises image data, and the method further comprises:
for each document:
extracting the image data from the document;
providing the image data to an attribute determination model;
determining, by the attribute determination model, an attribute associated with the document based on the image data; and
associating the document with the determined attribute as a label.

14. The method of claim 1, wherein each document comprises image data, and the method further comprises:
for each document:
extracting the image data from the document;
providing the image data to an image-based numerical representation generation module;
determining by the image-based numerical representation generation module, an image-based numerical representation of the document;
providing character data to a character-based numerical representation generation module;
determining by the character-based numerical representation generation module, a character-based numerical representation of the document;
providing, to a consolidated numerical representation generation module, the image-based numerical representation of the document and the character-based numerical representation of the document; and
generating, by the consolidated numerical representation generation module, a combined numerical representation of the character data and the image data of the document;
providing the combined numerical representation to an attribute prediction module; and
determining, by the attribute prediction module, an attribute associated with the document; and
associating the document with the determined attribute as a label.

15. The method of claim 12, wherein the attribute is an entity associated with the document.

16. The method of claim 1, wherein the documents are derived from previously reconciled accounting documents of an accounting system, each of which has been associated with a respective entity, and wherein a label of each document is indicative of the respective entity.

17. The method of claim 1, wherein the document is an accounting document and the class of documents includes one or more of: (i) an invoice; (ii) a credit note; (iii) a receipt; (iv) a purchase order; and (v) a quote.

18. A system comprising:
one or more processors; and
memory comprising computer executable instructions, which when executed by the one or more processors, cause the system to:
a) determine a plurality of documents associated with an entity;
b) for each document:
i) provide the document to a numerical representation generation model;
ii) generate, by the numerical representation generation model, a numerical representation of the document; and
iii) determine a document score for the document based on the numerical representation, wherein the document score comprises one or more confidence scores for corresponding one or more attributes of the document;
c) provide document scores for the documents to a clustering module;
d) determine, by the clustering module, one or more clusters, each cluster being associated with a class of the documents;
e) output, by the clustering module, a cluster identifier indicative of the class of each document; and
f) associate each document with its respective cluster identifier.

19. A computer-readable storage medium storing instructions that, when executed by a computer, cause the computer to perform operations including:
a) determining a plurality of documents associated with an entity;
b) for each document:
i) providing the document to a numerical representation generation model;
ii) generating, by the numerical representation generation model, a numerical representation of the document; and
iii) determining a document score for the document based on the numerical representation, wherein the document score comprises one or more confidence scores for corresponding one or more attributes of the document;
c) providing document scores for the documents to a clustering module;
d) determining, by the clustering module, one or more clusters, each cluster being associated with a class of the documents;
e) outputting, by the clustering module, a cluster identifier indicative of the class of each document; and
f) associating each document with its respective cluster identifier.

20. The system of claim 18, wherein one or more of the cluster identifiers are indicative of a low confidence score class of document for which one or more low confidence scores have been allocated and further causing the system to:
select the documents of the one or more low confidence score classes for label review; and/or
retrain a model used to generate confidence scores using documents from the one or more low confidence score classes of document.
